(19) United States
(12) Patent Application Publication
(10) Pub. No.: US 2003/0216087 A1
(43) Pub. Date: Nov. 20, 2003

(54) BOARD-TO-BOARD ELECTRICAL CONNECTOR AND METHOD FOR MANUFACTURING SAME

(76) Inventor: Weihua Pan, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/269,137

(22) Filed: Oct. 10, 2002

(30) Foreign Application Priority Data
May 17, 2002 (TW) 91110317

(51) Int. Cl. H01R 13/02

(52) U.S. Cl. 439/885

(57) ABSTRACT

An electrical connector (1) includes a housing (2) receiving contacts (3). The housing includes a central island portion (20) surrounded by connected sidewalls. The island portion is separated from the sidewalls by a moat-like mating groove. Receiving slots (200) each including a first channel (2000) and a second channel (2002) are defined in each of opposite sides of the island portion, the first channel being wider than the second channel. Each contact is received in a corresponding receiving slot, and includes a contact portion (32), a terminal portion (34) and a medial portion (30). In manufacturing, each of two series of contacts is connected with a common operation carrier (6). The terminal portion of each contact has an L-shaped pull portion (56). Pushing force is applied on the operation carriers. Then pulling force is applied at the pull portions until the terminal portions are completely exposed outside of the housing.

### BACKGROUND OF THE INVENTION

1. Field of the Invention

The present invention relates to a board-to-board electrical connector and a method for effectively make such connector, especially a method whereby parts of the connector can be installed quickly without causing damage.

2. Description of the Related Art

As detailed in pages 1737-1755 of Proceedings of 1990 National Electronic Packaging and Production Conference (NEPCON WEST '90) (V01.2), board to board electrical connectors have been widely used and applied in all kinds of electrical equipment to electrically connect two separate Printed Circuit Boards (PCBs). A conventional board-to-board connector comprises an insulative housing defining a plurality of channels, and a plurality of conductive contacts respectively received in the channels. Each contact comprises a medial portion, an arcuate resilient contact portion extending from the medial portion, and a terminal portion. The terminal portion extends substantially perpendicularly from the medial portion, and is used for soldering to a respective pad on a lower PCB by Surface Mounting Technology (SMT) soldering.

The conventional process for placing the contacts in the housing is to push the contacts into the channels to a certain extent with a common carrier that interconnects either the contact portions or the terminal portions of the contacts. If the carrier connects with the terminal portions, the contacts must be installed into the channels from the bottom face of the housing.

However, during the process of installing the contacts into the housing, the housing applies force on the contacts in a direction opposite to the direction of installation. This renders the housing liable to disengage from the contacts. In particular, when a mating complementary connector is detached from the board-to-board connector in normal use, the housing is prone to separate from the contacts. In addition, excessive or uneven pushing force may be exerted on the contacts during the installation process. The contacts may be improperly positioned in the channels, and the contact portions may be distorted. As a result, reliable electrical engagement between the contacts and conductors of the complementary connector may be impaired. Furthermore, the contacts are usually gold-plated for better electrical performance. If the contacts or the connector have to be discarded, this is costly.

Hence, a new board-to-board connector manufactured by an improved method is required to overcome the above-described disadvantages.

### SUMMARY OF THE INVENTION

An object of the present invention is to provide an electrical connector which enables safe installation of its contacts in its housing, thereby facilitating reliability of the contacts and effective electrical engagement of the connector with a complementary connector.

Another object of the present invention is to provide a method for manufacturing an electrical connector which enables safe installation of its contacts in its housing, thereby reducing defect run rates in mass production facilities.

A further object of the present invention is to provide an electrical connector having contacts reliably secured in a housing thereof.

In order to achieve the aforementioned objects, an electrical connector in accordance with a preferred embodiment of the present invention comprises an insulative housing receiving a plurality of conductive contacts. The housing comprises a central island portion surrounded by connected sidewalls. The island portion is separated from the sidewalls by a moat-like mating groove. A plurality of closely-spaced receiving slots is defined in each of opposite longitudinal sides of the island portion. Each slot comprises a first channel and a second channel. If a transverse cross-section of the housing is viewed, the first channel is wider than the second channel. Each contact comprises a contact portion, a terminal portion, and a medial portion which connects the contact portion with the terminal portion. The contact portion is flexible, and adapted to engage a mating contact of a complementary connector. The terminal portion extends approximately perpendicularly from the medial portion, and protrudes out of the bottom face of the housing for soldering to a printed circuit board.

In manufacturing the electrical connector, two series of contacts are made, one series for each longitudinal side of the island portion of the housing. Each series of contacts is stamped from a sheet of conductive metallic material. The series of contacts is connected with a common operation carrier. The terminal portion of each contact extends at a slight angle from the medial portion, and an L-shaped pull portion is formed at a distal end of the terminal portion. The series of contacts are inserted into its corresponding slots of the housing by applying force on the operation carrier. The pull portions are pulled away from the housing in a direction parallel to the slots until the terminal portions are completely exposed outside of the housing.

Other objects, advantages and novel features of the present invention will become more apparent from the following detailed description when taken in conjunction with the accompanying drawings. A copending application Ser. No. 10/243,427 with the same assignee, discloses a somewhat close approach.

### BRIEF DESCRIPTION OF THE DRAWINGS

FIG. 1 is a perspective view of an electrical connector in accordance with a preferred embodiment of the present invention.

FIG. 2 is a cross-sectional view of the electrical connector of FIG. 1, taken along line II-II of FIG. 1.

FIG. 3A is a front plan view of a series of contacts of the electrical connector of FIG. 1 connected with a common operation carrier.

FIG. 3B is a side plan view of FIG. 3A.

FIGS. 4A-4C are cross-sectional views of the electrical connector in accordance with the preferred embodiment of the present invention, showing successive steps of a preferred method for manufacturing the electrical connector.

### DESCRIPTION OF THE PREFERRED EMBODIMENT

Reference will now be made to the drawing figures to describe the present invention in detail.

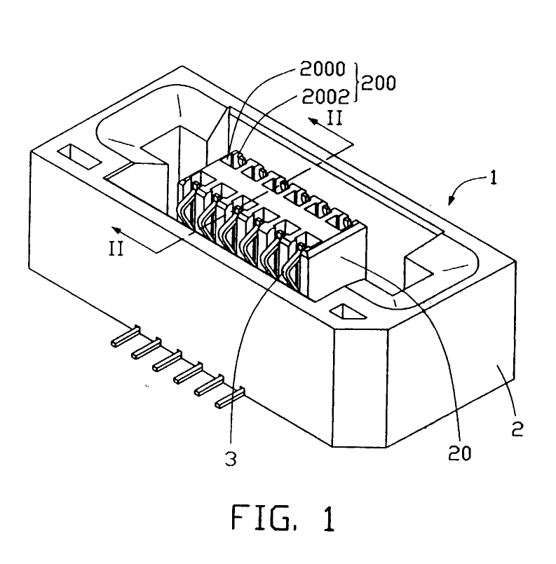

Referring to FIG. 1, an electrical connector 1 of the present invention comprises an insulative housing 2 having a top mating face and an opposite bottom face, and a plurality of conductive contacts 3 received in the housing 2. The housing 2 forms a central island portion 20. The island portion 20 is surrounded by connected sidewalls of the housing 2, but separated from the sidewalls by a moat-like mating groove. A plurality of closely-spaced receiving slots 200 is defined in each of opposite longitudinal sides of the island portion 20. The slots 200 span between the mating face and the bottom face. Each slot 200 comprises a first channel 2000 and a second channel 2002.

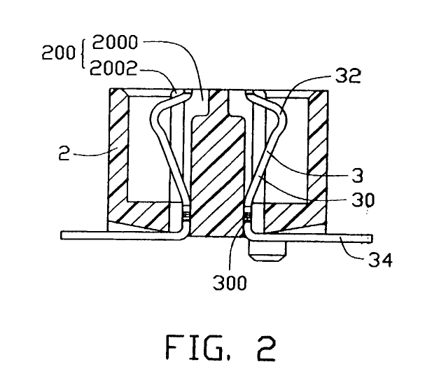

Referring also to FIG. 2, if a transverse cross-section of the housing 2 is viewed, the first channel 2000 is slightly wider than the second channel 2002.

Each contact 3 comprises a medial portion 30, an arcuate resilient contact portion 32 extending from one end of the medial portion 30, and a terminal portion 34 extending from an opposite end of the medial portion 30 in a direction approximately perpendicular to the medial portion 30. The medial portion 30 further forms a plurality of barbs 300 on each of opposite lateral edges thereof, for interferential engagement of the medial portion 30 in its corresponding slot 200 of the housing 2. The barbs 300 are securely received in the first channel 2000 such that the first channel 2000 is expanded in the vicinity of the barbs. Thus the contact 3 is firmly fastened in the slot 200. The contact portion 32 is flexible, and adapted to engage a mating contact of a complementary connector (not shown). The terminal portion 34 extends approximately perpendicularly from the medial portion 30, and protrudes out of the bottom face of the housing 2 for soldering to a printed circuit board (not shown).

A preferred method for manufacturing the electrical connector 1 will now be described in detail.

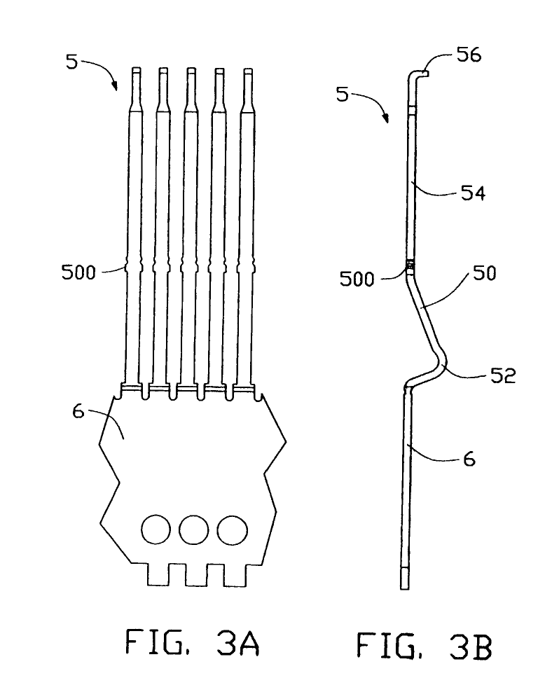

Firstly, referring to FIGS. 3A and 3B, two series of contacts 5 are made, one series for each longitudinal side of the island portion 20 of the housing 2. Each series of contacts 5 is stamped from a sheet of conductive metallic material. Each contact 5 comprises a medial portion 50, a contact portion 52 extending from the medial portion 50, a terminal portion 54 extending at a slight angle from the medial portion 50, and an L-shaped pull portion 56 formed at a distal end of the terminal portion 54. In addition, a plurality of barbs 500 is formed on each of opposite lateral edges of the medial portion 50. The series of contacts 5 is connected with a common operation carrier 6. The operation carrier 6 is adapted to simultaneously install the contacts 5 into the corresponding slots 200 of the housing 2 during the assembly process.

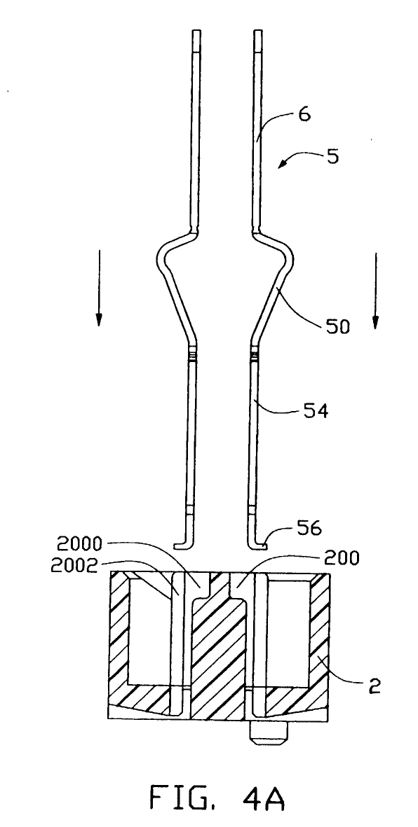

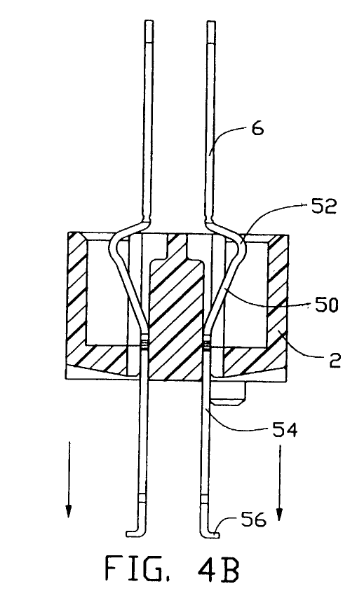

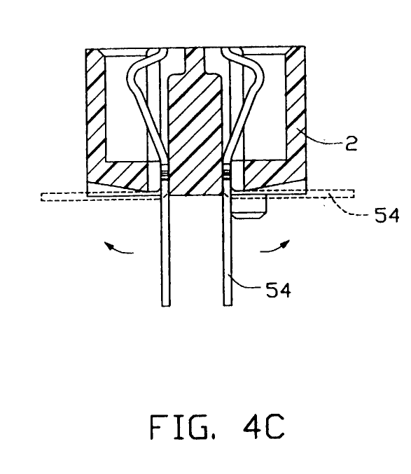

Secondly, referring to FIG. 4A, the series of contacts 5 is inserted into the corresponding slots 200 of the housing 2 by applying force on the operation carrier 6. The medial and terminal portions 50 of each contact 5 pass through only the first channel 2000 of the slot 200, while the pull portion 56 of each contact 5 passes through both the first channel 2000 and the second channel 2002 of the slot 200.

Thirdly, referring to FIG. 4B, the pull portions 56 of the contacts 5 protrude from the bottom face of the housing 2. The pull portions 56 are pulled away from the housing 2 in a direction parallel to the slots 200 until the terminal portions 54 are completely exposed outside of the housing 2.

Fourthly, referring to FIG. 4C, the operation carrier 6 is cut off from the adjacent contacts 5. The pull portions 56 are cut off from the terminal portions 54 of the contacts 5. The terminal portions 54 are bent to positions approximately perpendicular to the corresponding medial portions 50 of the contacts 5.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

What is claimed is:

1. An electrical connector comprising:
an insulative housing defining a plurality of receiving slots therein;
a plurality of conductive contacts received in the receiving slots, each of the contacts comprising a contact portion adapted to engage a complementary connector, a terminal portion for attachment to a circuit substrate, and a medial portion disposed between the contact portion and the terminal portion and adapted to fix the contact in a corresponding receiving slot; wherein
during assembly of the connector, the terminal portion of at least one of the contacts comprises a severable distal portion, and the contact portions of at least two adjacent of the contacts are severably connected with an operation element, whereby operation force can be applied at said operation element and said terminal portion in a same direction.

2. The electrical connector as described in claim 1, wherein the operation element is an operation carrier, and the distal portion is a pull portion.

3. The electrical connector as described in claim 2, wherein the operation carrier is used to apply a pushing force on contact portions connected therewith, whereby said contact portions are partly received in corresponding slots of the housing.

4. The electrical connector as described in claim 3, wherein the pull portion is used for applying a pulling force thereat, whereby said partially received contact portions are moved further into the housing to fasten the corresponding contacts in the corresponding receiving slots.

5. The electrical connector as described in claim 4, wherein each of the receiving slots further defines a first channel and a second channel, and the first channel is slightly wider than the second channel.

6. The electrical connector as described in claim 5, wherein the pull portion passes through the second channel of the corresponding slot when the pushing force is applied on the operation carrier.

7. The electrical connector as described in claim 5, wherein the medial portion of each of the contacts forms a plurality of barbs adapted to interferentially engage with at least one inner sidewall of the housing at the first channel of the corresponding receiving slot.

8. An electrical connector for electrically connecting a complementary connector to a circuit substrate, the electrical connector comprising:
an insulative housing having a mating face and bottom face, and a plurality of slots communicating therebetween;
a plurality of conductive contacts received in the slots respectively, each of the contacts comprising a medial portion, a contact portion extending from one end of the medial portion, and a terminal portion extending from an opposite end of the medial portion;
an opening defined at a bottom end of each of the slots, the opening comprising a first area and a second area in communication with the first area, the first area being substantially equal to a transect of the medial portion of the corresponding contact, and the second area being not equal to a projecting area of the contact portion of the corresponding contact on the bottom face of the housing.

9. The electrical connector as described in claim 8, wherein the slots span substantially perpendicularly and uniformly between the mating face and the bottom face of the housing.

10. The electrical connector as described in claim 8, wherein each of the contacts further comprises a pull portion at a distal end of the terminal portion, and a projecting area of the pull portion on the bottom face of the housing is substantially equal to the first and second areas combined.

11. The electrical connector as described in claim 9, further comprising an operation carrier connecting a plurality of the contacts, whereby force can be applied on the operation carrier to partially install said plurality of the contacts into the housing.

12. The electrical connector as described in claim 9, wherein each of the slots further defines a first channel and a second channel respectively in communication with the first and second areas of the corresponding opening, and a plurality of barbs is formed at opposite sides of the medial portion of the corresponding contact, the barbs providing interferential engagement of the corresponding contact in the first channel.

13. A method for manufacturing an electrical connector, comprising the steps of:
a. providing a plurality of conductive contacts connected to a common operation carrier, each of the contacts comprising a terminal portion, a pull portion extending from the terminal portion, a contact portion, and a medial portion interconnecting the contact portion with the terminal portion and adapted to fasten the contact inside the connector in a final position;
b. providing an insulative housing defining a plurality of receiving slots therein;
c. applying force on the operation carrier and moving the contacts into the receiving slots beginning with the pull portions, until the medial portions of the contacts are near the final position without engagement;
d. applying force on the pull portions and moving the contacts until the medial portions are fastened in the receiving slots in the final position; and
e. removing the operation carrier from the contacts.

14. The method for manufacturing an electrical connector as described in claim 13, further comprising the step of:
f. bending the terminal portions to positions substantially perpendicular to the respective medial portions.

15. The method for manufacturing an electrical connector as described in claim 14, further comprising the step of:
g. removing the pull portions from the terminal portions.

16. The method for manufacturing an electrical connector as described in claim 13, wherein each of the pull portions is substantially L-shaped.

17. The method for manufacturing an electrical connector as described in claim 13, wherein each of the receiving slots comprises a first channel and a second channel in communication with the first channel, and the first channel is wider than the second channel whereby the pull portion and terminal portion of the corresponding contact can pass through the slot in step c.

18. A method for manufacturing an electrical connector, comprising the steps of:
a. providing a plurality of contacts formed from a sheet of conductive material, each of the contacts being connected to a common operation carrier at one end thereof, a pull portion being provided around a portion of each of the contacts far opposite to said operation carrier;
b. providing a housing defining a plurality of receiving slots;
c. applying force on the operation carrier, the operation carrier moving the contacts partially into the receiving slots of the housing until the housing resists such movement; and
d. applying force on the pull portions to overcome said resistance of the housing and further move the contacts into the receiving slots whereby the contacts are fastened in the receiving slots.

19. The method for manufacturing an electrical connector as described in claim 18, further comprising the steps of:
e. removing the operation carrier from the contacts;
f. removing the pull portions from the corresponding contacts; and
g. moving the terminal portions of the contacts to positions substantially perpendicular to respective medial portions of the contacts.

20. The method for manufacturing an electrical connector as described in claim 18, wherein each of the contacts further comprises a medial portion, a contact portion extending from one end of the medial portion, and a terminal portion extending from an opposite end of the medial portion away from the contact portion.

21. The method for manufacturing an electrical connector as described in claim 20, wherein in step d) the contacts are fastened in the receiving slots at the medial portions.

22. The method for manufacturing an electrical connector as described in claim 18, wherein each of the receiving slots comprises a first channel and a second channel narrower than the first channel.

23. The method for assembling an electrical connector as described in claim 20, wherein a plurality of barbs is formed at opposite sides of the medial portion for providing interferential engagement of the medial portion in the housing.

24. The method for assembling an electrical connector as described in claim 18, wherein the pull portion is substantially L-shaped.

25. An electrical connector for electrically connecting a complementary electrical component to an electrical device, comprising:
a housing defining a plurality of receiving slots each comprising a first channel and a second channel;
a plurality of contacts received in the receiving slots, each of the contacts comprising a contact portion, a terminal portion, and a medial portion connecting the contact portion and the terminal portion; wherein
the first channel is adapted to fix the medial portion of a corresponding contact therein, the first channel is wider than the second channel, and the first and second channels are each substantially uniform from end to end.

26. The electrical connector as described in claim 25, wherein the contact portion further has an elastic arcuate portion.

27. The electrical connector as described in claim 25, wherein a plurality of barbs extends from opposite sides of the medial portion.

28. The electrical connector as described in claim 25, wherein the terminal portion extends out of the housing in a direction substantially perpendicular to the medial portion of the contact.

29. A method of assembling an electrical connector, comprising steps of:
providing an insulative housing with therein a plurality of passageways extending therethrough and between opposite first and second faces thereof;
providing a contact strip with a plurality of juxtaposed contacts commonly linked to a carrier, each of said contacts including a mating portion and a retention portion both adapted to be received in the corresponding passageway, and a tail portion adapted to be exposed to an exterior outside of the housing;
inserting the contacts into the corresponding passageways from the first faces in a first direction in a relatively free manner with a proper extent; and
pulling portions of the contacts from the second face to successively move said each of the contacts along said first direction in a relatively interfering manner until the contacts are positioned in a final position; wherein
said carrier is located outside of the housing and closer to the first face than the second face.

30. The method as described in claim 29, wherein said free manner terminates at physical interferential confrontation between the retention portion and the housing.
